(19) United States
(12) Patent Application Publication
(10) Pub. No.: US 2024/0183222 A1
(43) Pub. Date: Jun. 6, 2024

(54) REINFORCED SPREADER LADDER STEP AND LADDER HANDLE, LADDERS INCORPORATING SAME, AND RELATED METHODS

(71) Applicant: LITTLE GIANT LADDER SYSTEMS, LLC, Springville, UT (US)

(72) Inventors: Travis Mittanck, Springville, UT (US); N. Ryan Moss, Mapleton, UT (US); Tallon C. Beckstrom, Spanish Fork, UT (US); B. Scott Maxfield, Mapleton, UT (US)

(21) Appl. No.: 18/527,208

(22) Filed: Dec. 1, 2023

Related U.S. Application Data
(60) Provisional application No. 63/429,328, filed on Dec. 1, 2022.

(51) Int. Cl. E06C 7/50; E06C 1/20; E06C 7/16

(52) U.S. Cl. CPC E06C 7/50; E06C 1/20; E06C 7/16

(57) ABSTRACT

Ladder configurations and components are provided including a first assembly of rails and a second assembly of rails that are pivotable relative to each other between a collapsed configuration and an expanded configuration. A handle coupled to a rail extends inward from the rail and has an inner end resiliently deflectable between a clearance position and a weight bearing position that engages another rail as the ladder is carried by the handle. A spreader mechanism includes a platform extending between jointed linkages and that extends the top surface of a rung coupled to two of the rails. An inner end of the platform may be used as a handle to expand or collapse the ladder. The platform may be extruded and assembled with the rung in a manner limiting pinching or gaps at an interface between the platform and the rung.

### CROSS-REFERENCE TO RELATED APPLICATIONS

This application claims the benefit of and priority to U.S. Provisional Patent Application No. 63/429,328, filed on 1 Dec. 2022 and entitled, “REINFORCED SPREADER LADDER STEP AND LADDER HANDLE, LADDERS INCORPORATING SAME, AND RELATED METHODS,” the disclosure of which is incorporated herein in its entirety by this reference.

### TECHNICAL FIELD

The present disclosure generally relates to ladders, ladder systems, ladder components, and related methods and, more specifically, to platforms, steps, spreaders, handles, and grips and related methods of manufacturing and operating the same.

### BACKGROUND

Ladders are conventionally used to provide a user thereof with improved access to locations that might otherwise be inaccessible. Ladders come in many shapes and sizes, such as straight ladders, straight extension ladders, stepladders, and combination step and extension ladders. So-called combination ladders incorporate, in a single ladder, many of the benefits of other ladder designs.

Ladders are common tools for professional tradesman and homeowners alike. Sometimes the use of a ladder can be an awkward experience, even for those who use ladders on a regular basis, when certain tasks are to be performed while standing on a ladder. For example, it can be easy to lose one's balance on a ladder while working on an overhead project (e.g., painting a ceiling, changing a light bulb, etc.) Moreover, opening and closing the ladder may be cumbersome, particularly when the user needs to operate independent spreaders on each side of the ladder. Moving the ladder can also cause issues to users when the rails rotate relative to each other. There are also opportunities for improving the ergonomics, manufacturability, and stability of ladders for various applications. For these and other reasons, there is a constant need for improvements to ladders and related components.

### SUMMARY

One aspect of the present disclosure relates to a ladder comprising: a first assembly including a first pair of rails and a plurality of rungs extending between and coupled to the first pair of rails; a second assembly including a second pair of rails, with the second pair of rails being pivotally displaceable relative to the first pair of rails between a collapsed configuration and an expanded configuration; and a spreader mechanism comprising: a first pair of links respectively pivotally connected to the second pair of rails; a platform pivotally coupled with the first pair of links and pivotally coupled with a rung of the plurality of rungs, with the platform having an inner end portion positioned between the first assembly and the second assembly when the first assembly and the second assembly are in the expanded configuration; wherein in response to a force applied perpendicular to the inner end portion of the platform, first and second assemblies transition from the expanded configuration to the collapsed configuration.

In some embodiments, the platform includes a top surface in-plane with a top surface of the rung of the plurality of rungs.

In some embodiments, the rung includes a projecting portion extending behind a rear-facing surface of the first pair of rails. In some embodiments, the platform includes a support segment configured to rest on the projecting portion of the rung. The platform may include a guard portion at least partially covering a rear-facing surface of the rung when the first assembly and the second assembly are in the expanded configuration.

In some embodiments, the platform includes a guard portion configured to cover a gap between the rung and the platform when the first assembly and the second assembly are in the collapsed configuration.

In some embodiments, the platform has a constant cross-section across its lateral width. In some embodiments, the constant cross-section includes a hinge portion pivotably coupled with the rung.

Another aspect of the disclosure relates to a ladder, comprising: a first assembly including a first pair of rails and a plurality of rungs extending between and coupled to the first pair of rails; a second assembly including a second pair of rails, the second pair of rails being pivotally displaceable relative to the first pair of rails between a collapsed configuration and an expanded configuration; and a spreader mechanism comprising a pair of jointed linkages coupled with the first assembly and with the second assembly, with the spreader mechanism including a platform component having a consistent cross-section across its lateral width.

In some embodiments, the platform component is attached to a rung of the plurality of rungs without fasteners. The platform component may include a hinge portion insertable into a recess of a rung of the plurality of rungs. The hinge portion may be pivotally coupled to the recess. In some embodiments, the hinge portion is resiliently flexible and configured to press-fit into the recess.

In some embodiments, the platform component includes a guard portion configured to cover a rear surface of a rung of the plurality of rungs. In some embodiments, the guard portion is curved and configured to follow a curvature of the rear surface of the rung.

Yet another aspect of the disclosure relates to a ladder, comprising: a first assembly including a first pair of rails and a first plurality of lateral supports extending between and coupled to the first pair of rails; a second assembly including a second pair of rails and a second plurality of lateral supports extending between and coupled to the second pair of rails, with the second pair of rails being pivotally displaceable relative to the first pair of rails between a collapsed configuration and an expanded configuration; and a handle coupled to a first rail of the first pair of rails, the handle having an inner end including a tip movable between: a first position laterally inward of a laterally innermost surface of a rear wall of a second rail of the second pair of rails; and a second position contacting or laterally outward of the laterally innermost surface of the rear wall of the second rail of the second pair of rails.

In some embodiments, with the tip in the second position, the handle resists spreading of the ladder to the expanded configuration.

In some embodiments, the tip is elastically deflectable between the first position and the second position.

In some embodiments, when in the second position, the handle contacts a front-facing surface of the second rail.

In some embodiments, when in the second position, the tip extends into a channel of the second rail.

The above summary of the present invention is not intended to describe each embodiment or every implementation of the present invention. The figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is an isometric view of a ladder in an unfolded configuration.

FIG. 2 is an isometric view of the ladder of FIG. 1 in a folded configuration.

FIG. 3 is a partial isometric view of the ladder of FIG. 1.

FIG. 4 is a partial isometric view of the ladder of FIG. 2.

FIG. 5 is an isometric section view as taken through section lines 5-5 in FIG. 8.

FIG. 6 is an isometric section view as taken through section lines 5-5 in FIG. 8 with the handle deflected.

FIG. 7 is a central side section view of the ladder of FIG. 1 and a detail view of the central side section view.

FIG. 8 is a central side section view of the ladder of FIG. 2 and a detail view of the central side section view.

FIG. 9 is an isometric view of a platform and platform rung of the ladder of FIG. 1.

FIG. 10 is an isometric view of a platform and platform rung of the ladder of FIG. 2.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

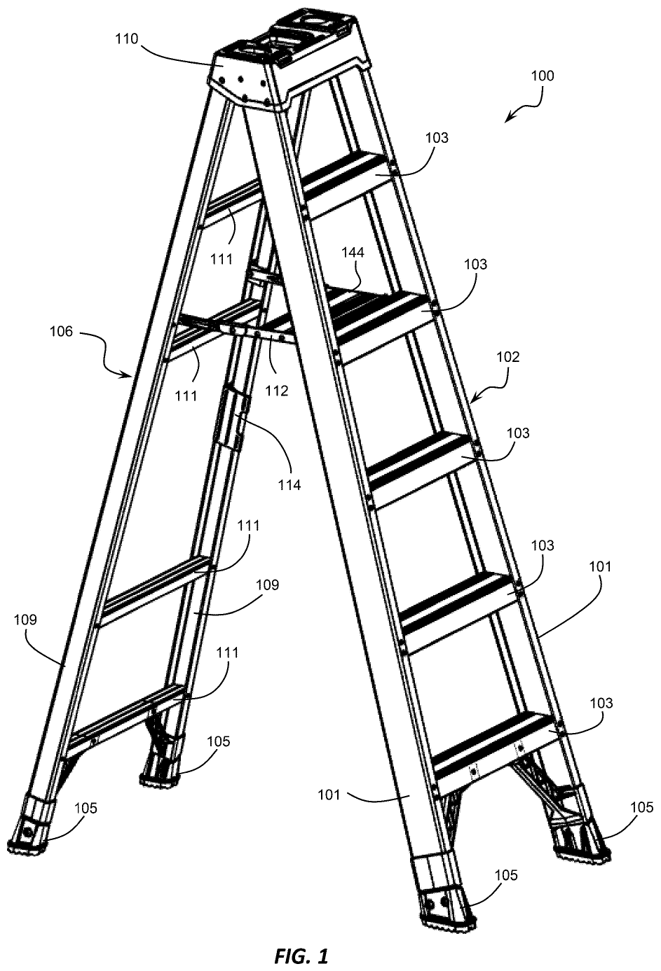

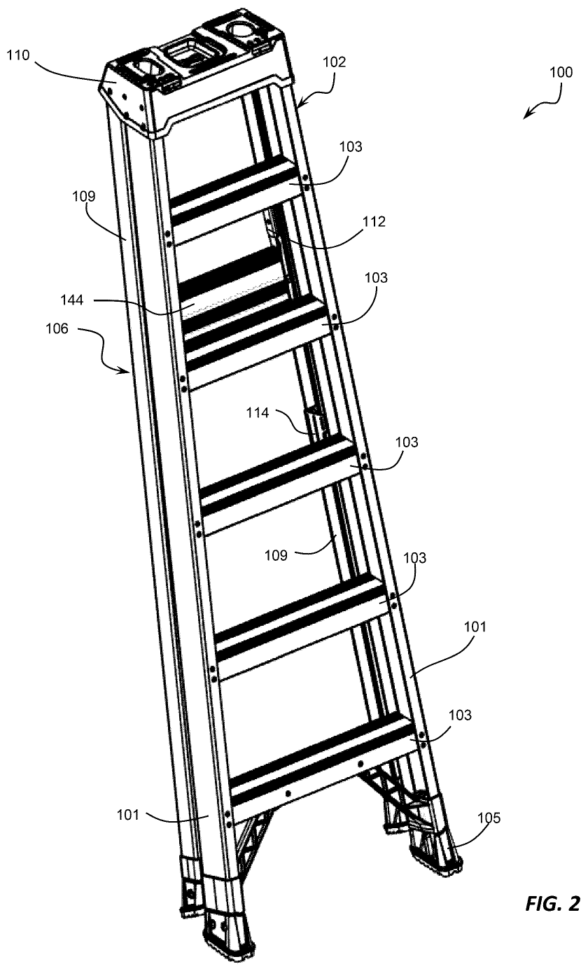

FIGS. 1-2 show isometric views of a ladder 100 according to an embodiment of the present disclosure. The ladder 100 may comprise a first assembly 102 (i.e., a first rail assembly or front rail assembly) including a first pair of rails 101 (e.g., front rails or primary rails) and a plurality of rungs 103 (i.e., steps or lateral supports) extending between, and coupled to, the first pair of rails 101. The ladder 100 may further include a second assembly 106 (i.e., a second rail assembly or rear rail assembly) including a second pair of rails 109 (e.g., rear or support rails) and a plurality of cross-braces 111 (e.g., rear horizontal struts or lateral supports). However, in the embodiment shown in FIGS. 1-2, the second assembly 106 does not include rungs for a user to climb on. Such a configuration is conventional for many stepladder configurations. However, in other embodiments, the second assembly 106 may include rungs and may be configured to support a user, for example, similar to the first assembly 102. The rungs 103 and cross-braces 111 may stiffen the first assembly 102 and second assembly 106, respectively, and may provide structural rigidity to the ladder 100.

The first and second assemblies 102 and 106 may each be coupled to a top cap 110. One of the first and second assemblies 102 and 106 (or both) may be configured to pivot relative to the top cap 110 such that the assemblies 102 and 106 may be displaced toward each other to a compact storage configuration (i.e., a flattened, folded, or collapsed configuration with front and rear feet 105 of the first and second assemblies 102, 106 approximated), as indicated in FIG. 2, and as will be appreciated by those of ordinary skill in the art. A free-standing configuration (i.e., an A-frame, expanded, or spread configuration) is shown in FIG. 1. The top cap 110 may include a number of features to enhance the efficiency and usability of the ladder 100, such as tool and part receptacles, handles, grips, safety alerts, and other features.

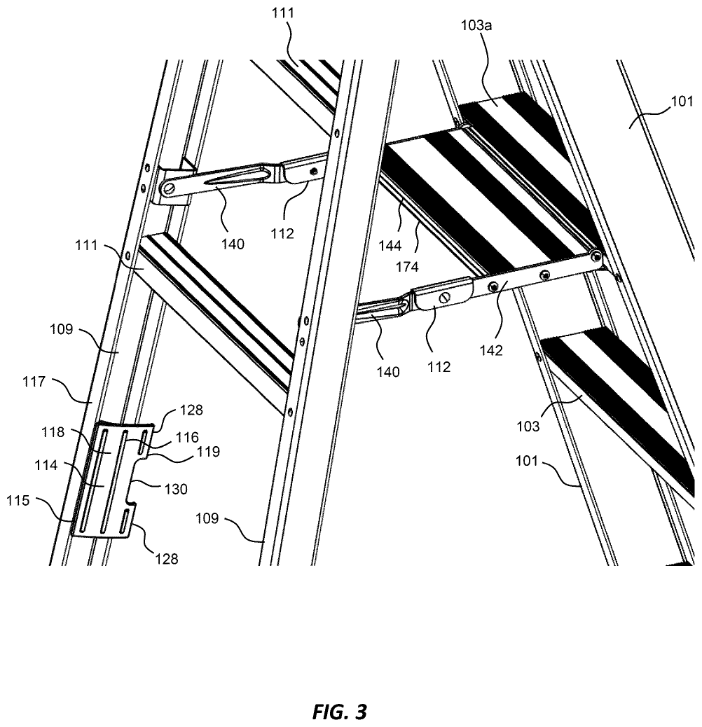

The ladder 100 may further include at least one spreader mechanism 112 coupled between the first and second assemblies 102 and 106 which extends therebetween to provide reversible or configurable structural rigidity to the ladder 100 and to provide a limit to the pivoting of one assembly 102 relative to the other assembly 106. The spreader mechanisms 112 may define a specific locked angular position of the first assembly 102 relative to the second assembly 106, and, when unlocked, the first and second assemblies 102, 106 may collapse toward each other. See also FIGS. 3-4 and 7-12 and their related descriptions herein.

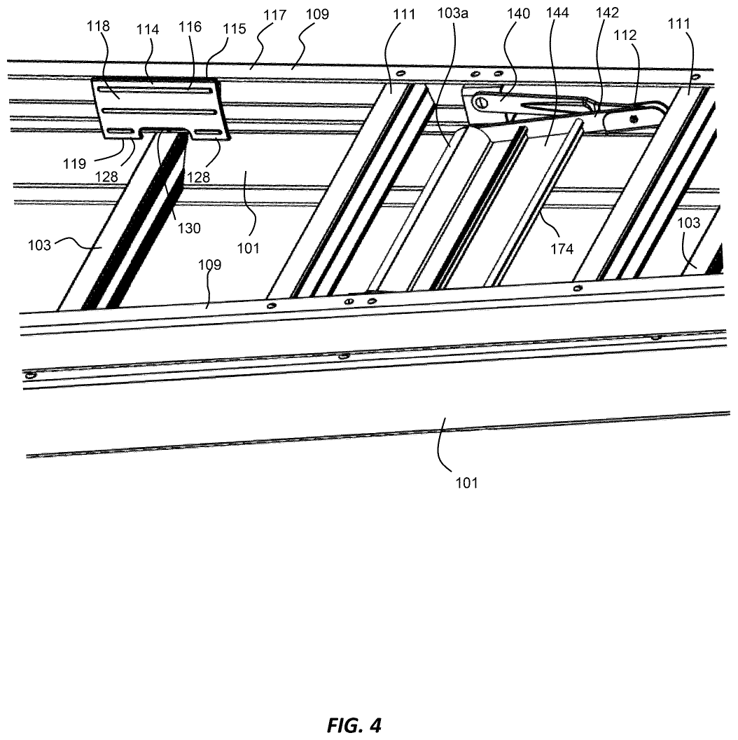

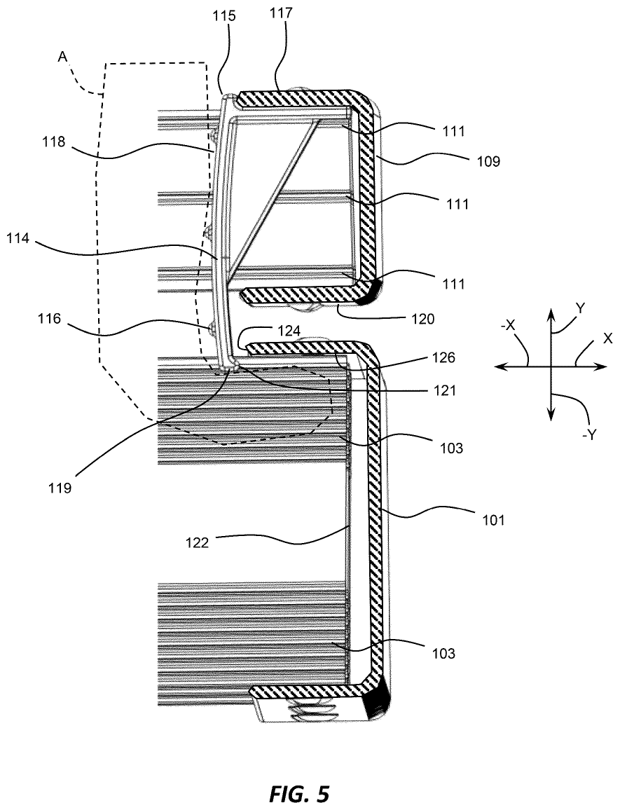

A handle 114 may be coupled to at least one of the rails 101, 109. The handle 114 is shown coupled to a rear rail 109 in FIGS. 1-2. The handle 114 may be configured as a grip or hand support for a user while the ladder 100 is in the collapsed configuration of FIG. 2. For example, a user may support the ladder with his or her hand on the handle 114 while the ladder 100 is collapsed and oriented with the rails 101, 109 being substantially horizontally or substantially parallel to a ground surface. See, e.g., FIGS. 4 and 5.

The handle 114 may be positioned on a generally central position along the length of the rail 109, such as a position that is about halfway along the longitudinal length of the rail 109. In some embodiments, the handle 114 is positioned at a longitudinal center of mass of the ladder 100 so that the weight of the ladder 100 is balanced on each longitudinal side of the handle 114 as the user holds the handle 114 with one hand or only by contacting the handle 114.

In some embodiments, the handle 114 may include a rear edge 115 substantially aligned with a rear face of the second assembly 106. In this manner, the grip surface 118 and the rear face 117 of the second assembly 106 may be substantially continuous. This may beneficially improve user comfort due to a lack of gaps or pits into which the user's hand may inadvertently enter when attempting to grasp the handle 114 or rail 109.

The handle 114 may be positioned between cross-braces 111 or between rungs 103 so that the vicinity of the handle 114 is clear of obstructions that would prevent the user from placing his or her fingers or palm on the handle 114 to support the weight of the ladder 100. See the expanded-configuration, rear isometric view of FIG. 3. In some embodiments, the handle 114 may correspond to and align with the positioning of another structural element of the ladder 100 such as, for example, a rung 103, as shown in the horizontal folded-configuration, rear-isometric view of FIG. 4.

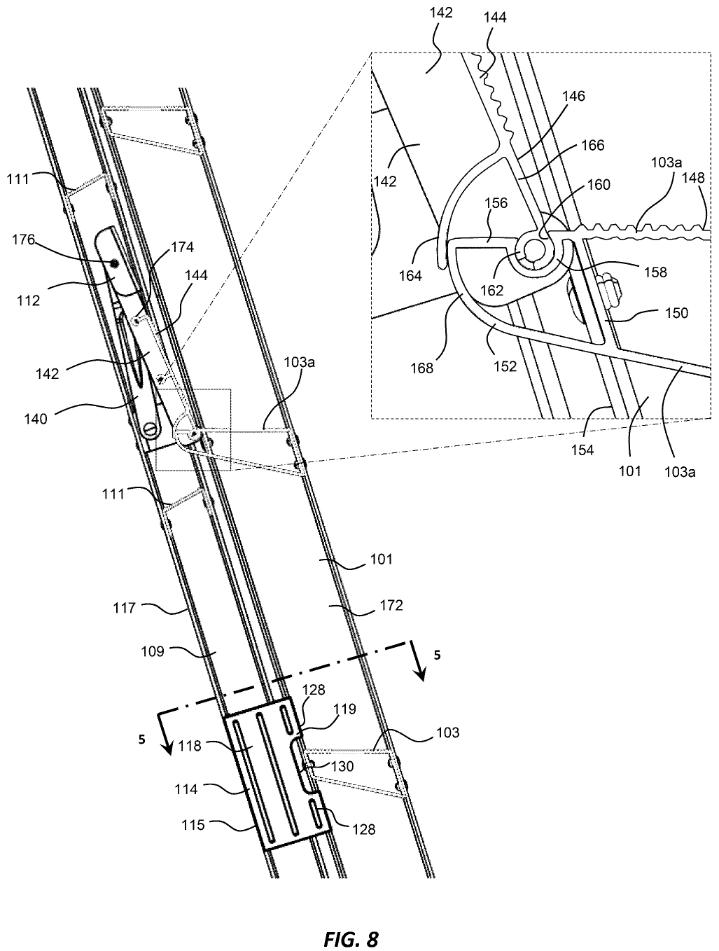

FIGS. 3-5 show that the handle 114 may include a set of surface features 116 positioned on a grip surface 118 (e.g., an laterally-inward-facing surface) thereof. The surface features 116 may enhance the user's ability to grip the handle 114 and may help limit sliding or slipping of the handle 114 from his or her hand. The surface features 116 may be primarily longitudinally oriented and longitudinally elongated, as shown in FIGS. 3-4, to especially limit sliding of the handle 114 on the user's hand in a front-to-back lateral direction (i.e., along an axis perpendicular to a plane in which the rear rails 109 are positioned). In some embodiments, the surface features 116 may comprise protrusions or ridges (see FIG. 5, which is a section view of the ladder 100 as taken through section lines 5-5 in FIG. 8) that engage the user's hand (e.g., hand A in FIG. 5) to give the user leverage or increased surface friction to maintain a hold on the handle 114 even if it sways or swings during transportation. In some embodiments, the surface features 116 may comprise recesses, dimples, knurling, bumps, texturing (e.g., similar to sandpaper or other rough surfaces), similar features, and combinations thereof to improve the securement of the handle 114 to a user's hand. In some embodiments, a series of spaced apart surface features 116 may be positioned across the grip surface 118.

The handle 114 may also comprise an inner end 119 (e.g., a frontal end, as shown in FIGS. 3-5, or a rear end, if the handle 114 is attached to one of the front rails 101). In some embodiments, the handle 114 may be referred to as having its inner end 119 extending away from an outer plane of the rails 101 or 109, wherein the outer plane is defined by the primary outer surfaces of the rails 101 or 109 (e.g., surface 117 for rail 109). The handle 114 may have its inner end 119 configured to project laterally inward (e.g., forward) from a front surface 120 of a rear rail 109 (e.g., in the −Y direction of FIG. 5). The inner end 119 may comprise a hooked, curved, or otherwise outer-extending tip 121 that is extendable past an innermost sidewall surface 124 of the front rail 101 and, in some embodiments, into a channel 122 of the front rail 101. See FIG. 5. The inner end 119 may provide a support for a user's fingers as the user grasps the handle 114 and touches an inner surface of the channel 122, as indicated by hand A in FIG. 5. In some embodiments, the user may grasp inner end 119 without contacting the front rail 101.

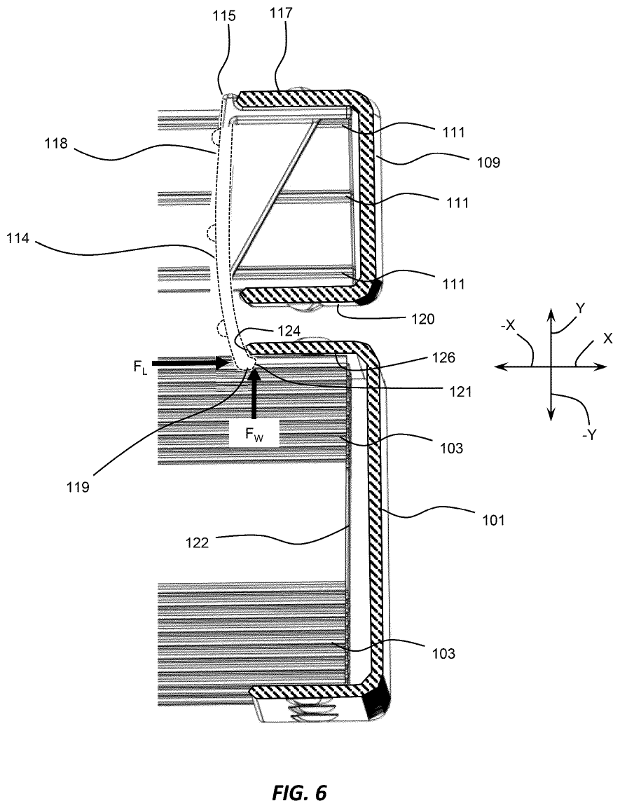

Additionally, in some embodiments, the tip 121 of the inner end 119 may be laterally outwardly deflectable (e.g., parallel to direction X in FIG. 5, as shown in broken lines in FIG. 6) in response to a laterally outward-directed force F_{L} on the handle 114. The tip 121 may deflect sufficiently to engage the innermost sidewall surface 124 or front-facing surface 126 of the channel 122 in response to the weight of the ladder 100 being borne by the hand (e.g., A) in contact with the handle 114. Deflection of the tip 121 in this manner may produce a force F_{W} applied to a surface 124, 126 of the rail 101 that resists the unfolding or spreading of the ladder. For example, the tip 121 may increase friction or mechanically interlock with the front rail 101 to prevent the front rail 101 from moving forward (i.e., along direction −Y in FIG. 5). In some configurations, contact between the tip 121 and the innermost sidewall surface 124 may increase friction between the handle 114 and front rail 101 or the front-facing surface 126. In some embodiments, contact between the tip 121 and the front-facing surface 126 may mechanically interfere with movement of the surface 126 in the −Y direction. Thus, the user's hand and the handle 114 may collectively apply the force F_{W} that resists any frontal (i.e., −Y) movement of the front rail 101 relative to the rear rail 109.

In some cases, when the ladder's weight is not applied to the handle 114, the handle 114 may resiliently deflect away from the front rail 101 and out of contact with the surfaces 124, 126 of the front rail 101. Thus, the ladder 100 is able to freely fold and unfold when it is not being carried by the handle 114. In such embodiments, the handle 114 does not create interference that would unintentionally catch on the front rail 101 when the user tries to unfold the front rail 101 along the Y axis. The handle 114 may elastically deform to a weight-supporting position (i.e., toward the front rail 101 (along the X direction)) when grasped by the user or when the handle 114 bears at least some of the weight of the ladder 100, and the handle 114 may then automatically and resiliently deform to a non-weight-supporting position (i.e., a cleared position or movement clearance position) when not grasped or when the handle 114 does not bear the weight of the ladder. No part of the tip 121 may be positioned in the channel 122 or in the frontal/−Y direction relative to the front-facing surface 126 of the rail 101 when the handle 114 is in the non-weight-supporting position.

In some embodiments, the handle 114 may have its inner end 119 formed with at least two tabs 128, wherein a gap 130 is formed between the tabs 128 to receive a rung 103 of the front rail 101 when the ladder 100 is folded. See FIGS. 3-4. In this manner, the handle 114 may be positioned to be longitudinally/vertically at or nearly at the same position as one of the rungs 103 of the first assembly 102. The user may grasp the handle 114 and at least partially grasp or touch the rung 103 at the handle 114 when holding the ladder 100. The rung 103 surfaces may therefore be used as additional support and grip surfaces for carrying the ladder 100 while the handle 114 is being held. For example, the user may place two fingers on each side of the rung 103 (i.e., two fingers per tab 128) when grasping the handle 114, and the inner surfaces of the fingers at the rung 103 may touch the rung 103 to help provide additional stability to the first assembly 102 as the ladder 100 is carried.

Turning now to FIGS. 3-4 and 7-10, the ladder 100 may include may include at least one spreader mechanism 112 on each side of the ladder. The spreader mechanisms 112 may comprise a pair of jointed linkages including a first pair of links 140 that are pivotally joined to the second assembly 106 and a second pair of links 142 that are coupled to sides of a platform 144 that is pivotally joined to a rung 103 (e.g., platform rung 103a). The spreader mechanisms 112 may therefore pivot upward when moved to a collapsed configuration, and the spreader mechanisms 112 may be straightened when moved to the standing or unfolded configuration. The platform 144 may also pivot with the spreader mechanisms 112 and may be positioned between a first plane defined by the outer front faces of the front rails 101 and a second plane defined by the outer rear faces of the rear rails 109 when in the collapsed configuration. In some embodiments, the second pair of links 142 and the platform 144 may be integrally formed as a single part.

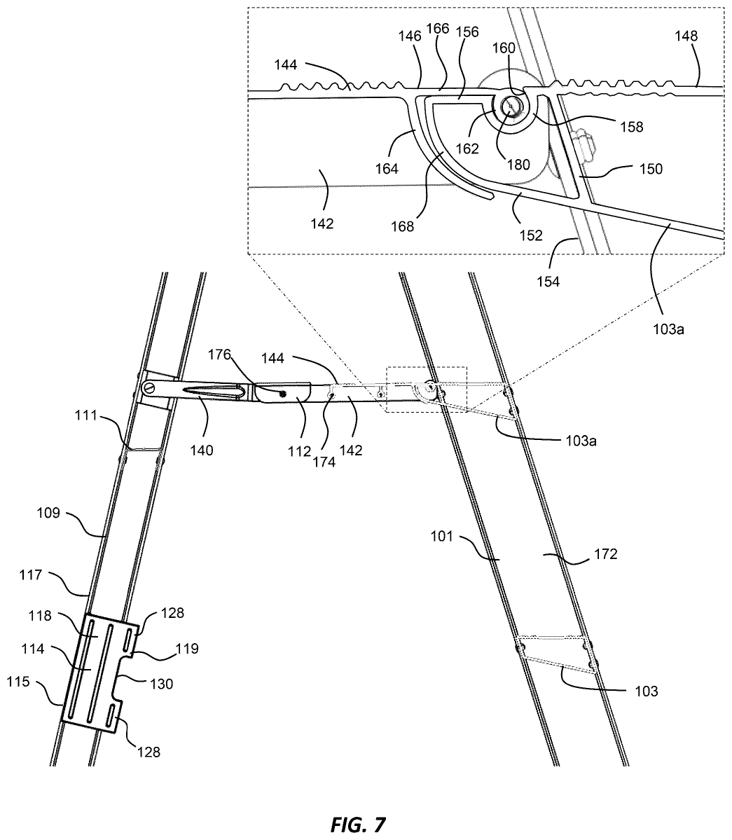

The platform 144 may have a top surface 146 that extends from and is substantially in-plane with the top surface 148 of the platform rung 103a to which the platform 144 is directly coupled when in the unfolded condition. See FIG. 7. It is noted that “directly coupled” as used herein contemplates the use of appropriate hardware, such as a bracket. The platform 144 may therefore extend the surface area of the rung 103 and may provide a larger surface area for the user on which the user may stand when using the ladder 100. The top surface 146 may comprise a set of ridges or other grip features configured to extend into contact with a user's foot, shoe, toolbox, or other object placed on the platform 144.

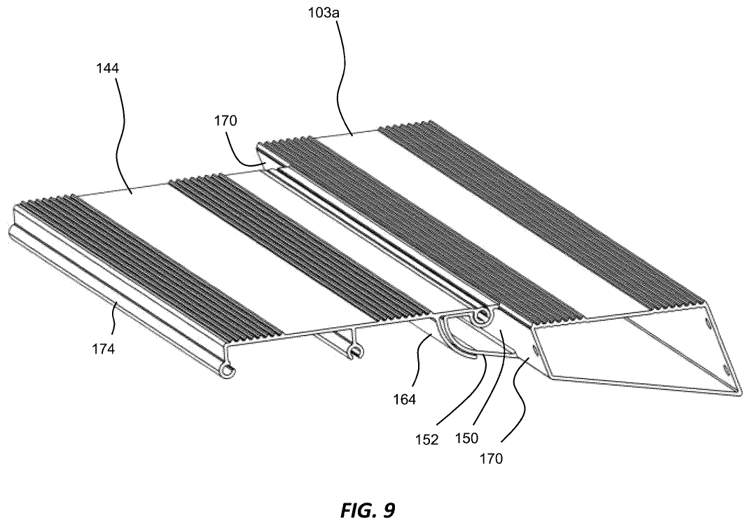

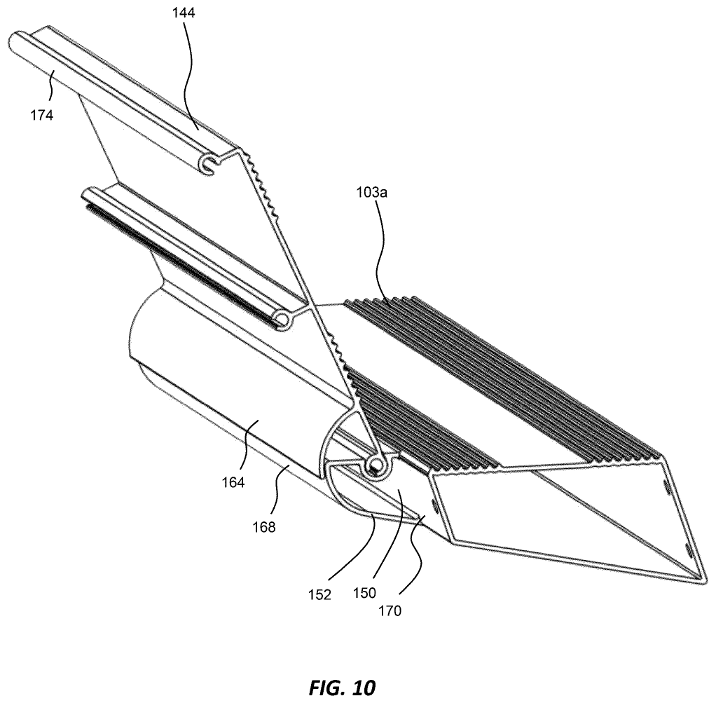

The rung 103 may comprise a rail-attachment portion 150 configured to directly couple and affix to the rail 101 (e.g., using fasteners or adhesives). See also FIGS. 9-10. The platform rung 103a may also comprise a rearward-projecting portion 152 that extends behind a rear-facing surface 154 of the rail 101. The rearward-projecting portion 152 may include a top portion 156 that is vertically offset lower than the top surface 148 of the platform rung 103a. The top portion 156 may also have a substantially flat and horizontal top surface and a recessed hinge portion 158 (i.e., a substantially cylindrical recessed portion) which includes a top opening 160 through which a hinge portion 162 (i.e., a substantially cylindrical portion) of the platform 144 is positionable. The platform 144 may also comprise a guard portion 164 at least partially covering a rear side of the rearward-projecting portion 152 of the platform rung 103a when the ladder 100 is in the free-standing, unfolded configuration of FIG. 7. Between the hinge portion 162 and the guard portion 164, the platform 144 may include a support segment 166 (i.e., a reinforcement section) configured to abut the top surface of top portion 156 of the rearward-projecting portion 152 of the platform rung 103a. As used herein, parts that “abut” or are “abutting” have substantial face-to-face contact between each other, as opposed to merely touching a tip or edge of one part to a face of another part.

As shown in FIG. 7, when the ladder 100 is in the free standing, unfolded condition, platform 144 is substantially horizontal, and the support segment 166 rests on the top surface of portion 156 of the platform rung 103a. The platform rung 103a therefore provides stability to the platform 144 in a manner that helps prevent rotation of the inner end of the platform 144 relative to the hinge portion 162 in addition to the connection at the hinge formed by the coupled hinge portions 158, 162. In some embodiments, the guard portion 164 of the platform 144 also contacts the rear-facing side 168 of the rearward-projecting portion 152 of the platform rung 103a. Contact between the guard portion 164 and rear-facing side 168 may provide additional support and stability for the platform 144 relative to the platform rung 103a, thereby providing comfort and security for a user of the ladder 100.

The hinge portion 162 of the platform 144 may comprise a c-shaped side profile (i.e., a gap or slit along a lateral width of the portion 162) to allow compression of the hinge portion 162 and a resilient snap-fit insertion into the hinge portion 158 of the platform rung 103a through the top opening 160. Accordingly, assembly and manufacturing of the ladder 100 may be simplified. In some embodiments, the platform 144 may slide laterally to insert the hinge portion 162 into the platform rung 103a at hinge portion 158. For example, as shown in FIGS. 9-10, the hinge portion 158 may define a groove into which the other hinge portion 162 may be inserted.

As shown in FIG. 8, when the ladder 100 is in the collapsed, folded condition, platform 144 may have its top surface 146 significantly angled, and in some cases may be at or near a perpendicular direction, relative to the top surface 148 of the platform rung 103a. The hinge formed by the hinge portions 158, 162 may facilitate movement of the platform 144 relative to the platform rung 103a without creating a large pinching interface where tools or debris could be caught or collected. As the platform 144 pivots upward to the collapsed position, the guard portion 164 may have a curvature that ensures it follows and remains immediately adjacent to, or in contact with, the rear-facing side 168 of the platform rung 103a. The length of the guard portion 164 may be sufficiently sized to prevent the top surface of the top portion 156 of the platform rung 103a from being exposed, even when the ladder 100 is collapsed. Thus, the guard portion 164 may prevent a user's fingers or tools from being clamped between the support segment 166 and the top portion 156 if they are near the rear-facing side 168 of the platform rung 103a as the ladder 100 opens.

FIGS. 9-10 illustrate isometric views of the platform 144 and platform rung 103a isolated from other parts of the ladder 100. The platform rung 103a may have a greater lateral width than the platform 144, thereby allowing at least one intermediate rear-facing surface 170 of the platform rung 103a to be directly coupled to and abutting with a surface of the first rail 101, such as an inner surface of the channel 172 of the rail. See FIGS. 7-8. The intermediate rear-facing surface 170 may be formed on the attachment portion 150 of the platform rung 103a.

The platform 144 may also comprise an inner end portion 174 that extends between the spreader mechanisms 112 of the ladder 100 on the forward side of the hinges 176 (see FIGS. 7-8) that join the links 140, 142. The inner end portion 174 may be useable as a grip or handle at which a user may grasp the platform 144. When the user wants to fold the ladder 100, the inner end portion 174 may be pulled upward, thereby pivoting the hinges 176 and collapsing the ladder via the links 140, 142. The connection of the platform across the spreader mechanisms 112 allows the spreader mechanisms 112 to pivot on both sides of the ladder 100 simultaneously. Accordingly, a user may collapse or unfold/lock the platform 144 using a single hand grasping the inner end portion 174, and the inner end portion 174/handle portion at which the user transitions the configuration of the ladder 100 may also serve as a platform and step on which the user may stand in an elevated position on the ladder 100. Furthermore, the inner end portion 174 may move from the unfolded configuration to the folded configuration by an arm reaching through the front and rear rails 101, 109 without interference. In other words, the arm may reach between the rails 101/109, grasp the inner end portion 174, and fold or unfold the ladder 100 in a single motion and without repositioning their hand or fingers relative to the inner end portion 174. The hand or fingers will not be pinched or crushed by another part of the ladder, and only a single, continuous movement of the hand or fingers is needed (e.g., as compared to a movement where a user must make at least a first movement to “unlock” spreaders and the must make a second movement to move the first and second assemblies relative to each other). The inner end portion 174 may be moved to simultaneously unlock the spreader mechanisms 112 and smoothly collapse the ladder by applying a consistent force via the hand to the inner end portion 174 alone. In some embodiments, the user may also unlock and collapse the ladder 100 by consistently pressing in a perpendicular direction (e.g., upward) on the bottom of the platform 144. Similarly, the user may apply a perpendicular force to the top surface of the platform 144 (whether or not at the inner end portion 174) to spread and lock the spreader mechanisms 112.

The platform 144 and platform rung 103a may be extruded parts configured for cost-effective manufacturing and assembly. As shown in FIGS. 9-10, the platform 144 may be extruded to a predetermined width including all of its flanges (e.g., 146, 166, 162, 168), cut to width (if needed), and essentially directly moved (i.e., ignoring minor finishing steps such as deburring or inspection) to assembly with the platform rung 103a and links 142 without machining or other additional significant processing. Accordingly, the platform 144 may have a consistent cross-section across its entire lateral width due to its manufacturing as a linear extrusion. In some embodiments, the platform 144 may be pivotally attached to the platform rung 103a without fasteners, e.g., by a resilient press-fit or snap-fit of the hinge portion 162 into the rung's hinge portion 158. In some cases, an optional rod (e.g., 180 in FIG. 7) may be inserted into the hinge portions 162, 158 after assembly to limit or prevent withdrawal of the hinge portions from each other.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A ladder, comprising:
a first assembly including a first pair of rails and a plurality of rungs extending between and coupled to the first pair of rails;
a second assembly including a second pair of rails, the second pair of rails being pivotally displaceable relative to the first pair of rails between a collapsed configuration and an expanded configuration; and
a spreader mechanism comprising:
a first pair of links respectively pivotally connected to the second pair of rails;
a platform pivotally coupled with the first pair of links and pivotally coupled with a rung of the plurality of rungs, the platform having an inner end portion positioned between the first assembly and the second assembly when the first assembly and the second assembly are in the expanded configuration;
wherein in response to a force applied perpendicular to the inner end portion of the platform, first and second assemblies transition from the expanded configuration to the collapsed configuration.

2. The ladder of claim 1, wherein the platform includes a top surface in-plane with a top surface of the rung of the plurality of rungs.

3. The ladder of claim 1, wherein the rung includes a projecting portion extending behind a rear-facing surface of the first pair of rails.

4. The ladder of claim 3, wherein the platform includes a support segment configured to rest on the projecting portion of the rung.

5. The ladder of claim 1, wherein the platform includes a guard portion at least partially covering a rear-facing surface of the rung when the first assembly and the second assembly are in the expanded configuration.

6. The ladder of claim 1, wherein the platform includes a guard portion configured to cover a gap between the rung and the platform when the first assembly and the second assembly are in the collapsed configuration.

7. The ladder of claim 1, wherein the platform has a constant cross-section across its lateral width.

8. The ladder of claim 7, wherein the constant cross-section includes a hinge portion pivotably coupled with the rung.

9. A ladder, comprising:
a first assembly including a first pair of rails and a plurality of rungs extending between and coupled to the first pair of rails;
a second assembly including a second pair of rails, the second pair of rails being pivotally displaceable relative to the first pair of rails between a collapsed configuration and an expanded configuration; and
a spreader mechanism comprising a pair of jointed linkages coupled with the first assembly and with the second assembly, the spreader mechanism including a platform component having a consistent cross-section across its lateral width.

10. The ladder of claim 9, wherein the platform component is attached to a rung of the plurality of rungs without fasteners.

11. The ladder of claim 9, wherein the platform component includes a hinge portion insertable into a recess of a rung of the plurality of rungs.

12. The ladder of claim 11, wherein the hinge portion is pivotally coupled to the recess.

13. The ladder of claim 11, wherein the hinge portion is resiliently flexible and configured to press-fit into the recess.

14. The ladder of claim 9, wherein the platform component includes a guard portion configured to cover a rear surface of a rung of the plurality of rungs.

15. The ladder of claim 14, wherein the guard portion is curved and configured to follow a curvature of the rear surface of the rung.

16. A ladder, comprising:
a first assembly including a first pair of rails and a first plurality of lateral supports extending between and coupled to the first pair of rails;
a second assembly including a second pair of rails and a second plurality of lateral supports extending between and coupled to the second pair of rails, the second pair of rails being pivotally displaceable relative to the first pair of rails between a collapsed configuration and an expanded configuration; and
a handle coupled to a first rail of the first pair of rails, the handle having an inner end including a tip movable between:
a first position laterally inward of a laterally innermost surface of a rear wall of a second rail of the second pair of rails; and
a second position contacting or laterally outward of the laterally innermost surface of the rear wall of the second rail of the second pair of rails.

17. The ladder of claim 16, wherein with the tip in the second position, the handle resists spreading of the ladder to the expanded configuration.

18. The ladder of claim 16, wherein the tip is elastically deflectable between the first position and the second position.

19. The ladder of claim 16, wherein when in the second position, the handle contacts a front-facing surface of the second rail.

20. The ladder of claim 16, wherein when in the second position, the tip extends into a channel of the second rail.
